(19) United States
(12) Patent Application Publication
(10) Pub. No.: US 2023/0264924 A1
(43) Pub. Date: Aug. 24, 2023

(54) INFORMATION PROCESSING SYSTEM, COMMUNICATION APPARATUS, AND NON-TRANSITORY COMPUTER-READABLE STORAGE MEDIUM

(71) Applicant: NEC Corporation, Minato-ku, Tokyo (JP)

(72) Inventor: Yasuji SAITO, Tokyo (JP)

(73) Assignee: NEC Corporation, Minato-ku, Tokyo (JP)

(21) Appl. No.: 18/010,101

(22) PCT Filed: Jun. 14, 2021
(86) PCT No.: PCT/JP2021/022522

§ 371 Date: Dec. 13, 2022

(30) Foreign Application Priority Data
Jun. 23, 2020 (JP) 2020-107864

(51) Int. Cl. B66B 1/46; B66B 1/14; B66B 1/34

(52) U.S. Cl. CPC B66B 1/468; B66B 1/14; B66B 1/3461; B66B 2201/4676

(57) ABSTRACT

An equipment operation apparatus (100) includes: a connection unit (102) that acquires apparatus identification information for distinguishing a plurality of operated apparatuses (10) from each other and connects to a communication apparatus (200) communicable with a controller (20) of an operated apparatus (10) indicated by the apparatus identification information; and a display processing unit (104) that causes, when a connection to the communication apparatus (200) is established, a display unit (110) to display an operation screen for operating the operated apparatus (10) controlled by the controller (20) communicable with the communication apparatus (200).

### TECHNICAL FIELD

The present invention relates to an information processing system, a communication apparatus, a control method therefor, and a program.

### BACKGROUND ART

Patent Document 1 describes a system controlling an elevator provided in a building including a door with an electric lock. The document describes that the system controls the elevator in conjunction with release and locking of the electric lock provided on the door and controls the elevator in accordance with an instruction to the elevator transmitted from a personal information terminal held by a person, such as a call for the elevator or an instruction about a destination floor. The document also describes that since an instruction to the elevator is activated only after a password, a personal ID, or the like for determining a person is input, a person other than a specified person cannot release or lock the electric lock, or use the elevator.

Patent Document 2 describes that when installing a similar application on a smartphone of a user, the application is downloaded by reading a QR code (registered trademark) and accessing a web page, further inputting a password by the user causes the password to be registered in a user authentication unit in an elevator control board in association with identification information of the smartphone, and when a password is input at activation of the application, authentication processing of determining whether the user is a legitimate user is performed, and when approved, an operation screen for operating an elevator is displayed on the smartphone.

### RELATED DOCUMENTS

### Patent Documents

Patent Document 1: Japanese Patent Application Publication No. 2006-69700

Patent Document 2: Japanese Patent Application Publication No. 2015-51842

### SUMMARY OF INVENTION

### Technical Problem

An operated apparatus operating by a user operating an operation unit poses a risk of becoming a source of an infectious disease due to unspecified persons touching the operation unit by hand. There are various operated apparatuses used by unspecified persons in addition to an elevator described in the aforementioned documents. Examples of such apparatus include cookware such as a coffee maker at a convenience store, a drink dispenser at a family restaurant, a vending machine, and a fare adjustment machine at a parking lot.

In order to reduce the risk of contracting an infectious disease, it is desired that various persons can operate such equipment requiring manual operation without touching the equipment.

The present invention has been made in view of the aforementioned circumstances, and an object thereof is to enable equipment requiring operation to be operated by various persons without touching the equipment by hand.

### Solution to Problem

The present invention provides a program for causing a computer to function as:

a connection unit that acquires apparatus identification information for distinguishing a plurality of apparatuses from each other, and connects to a communication unit communicable with a control unit of an apparatus indicated by the apparatus identification information;

a display processing unit that, when a connection to the communication unit is established, causes a display unit to display an operation screen for operating the apparatus communicable with the communication unit; and

a transmission unit that transmits an operation instruction input by operating the operation screen to the communication unit and causes the operation instruction to be transferred to the control unit of the apparatus.

The present invention provides a communication apparatus including:

a first communication unit that wirelessly communicates with a mobile terminal apparatus including a computer executing the aforementioned program;

a second communication unit that communicates with control units of a plurality of apparatuses;

a reception unit that, when a connection to the mobile terminal apparatus is established through the first communication unit, receives, from the mobile terminal apparatus, apparatus identification information for distinguishing the plurality of apparatuses from each other;

a first transmission unit that transmits, through the first communication unit, information for causing a display unit in the mobile terminal apparatus to display an operation screen for operating the apparatus, based on the received apparatus identification information; and

a second transmission unit that, when receiving an operation instruction to the apparatus from the mobile terminal apparatus through the first communication unit, transmits the operation instruction to the control unit of the apparatus through the second communication unit.

The present invention provides a communication apparatus control method including, by a communication apparatus including a first communication unit that wirelessly communicates with a mobile terminal apparatus and a second communication unit that communicates with control units of a plurality of apparatuses:

when a connection to the mobile terminal apparatus is established through the first communication unit, receiving, from the mobile terminal apparatus, apparatus identification information for distinguishing the plurality of apparatuses from each other;

transmitting, through the first communication unit, information for causing a display unit in the mobile terminal apparatus to display an operation screen for operating the apparatus, based on the received apparatus identification information; and,

when receiving an operation instruction to the apparatus from the mobile terminal apparatus through the first communication unit, transmitting the operation instruction to the control unit of the apparatus through the second communication unit.

The present invention provides a program for causing a computer to function as:

a first communication unit that wirelessly communicates with a mobile terminal apparatus;

a second communication unit that communicates with control units of a plurality of apparatuses;

a reception unit that, when a connection to the mobile terminal apparatus is established through the first communication unit, receives, from the mobile terminal apparatus, apparatus identification information for distinguishing the plurality of apparatuses from each other;

a first transmission unit that transmits, through the first communication unit, information for causing a display unit in the mobile terminal apparatus to display an operation screen for operating the apparatus, based on the received apparatus identification information; and

a second transmission unit that, when receiving an operation instruction to the apparatus from the mobile terminal apparatus through the first communication unit, transmits the operation instruction to the control unit of the apparatus through the second communication unit.

The present invention provides an information processing system including:

a mobile terminal apparatus operated by a user of an apparatus; and

a communication apparatus communicable with a control unit of the apparatus, wherein

the mobile terminal apparatus includes:
a connection unit that acquires apparatus identification information for distinguishing a plurality of the apparatuses from each other and connects to the communication apparatus communicable with the control unit of an apparatus indicated by the apparatus identification information;
a display processing unit that, when a connection to the communication apparatus is established, causes a display unit to display an operation screen for operating the apparatus communicable with the communication apparatus; and
a transmission unit that transmits an operation instruction input by operating the operation screen to the control unit of the apparatus through the communication apparatus.

Note that any combination of the components described above, and representations of the present invention converted between a method, an apparatus, a system, a storage medium, a computer program, and the like are also valid as embodiments of the present invention.

Further, various components of the present invention do not necessarily need to be individually independent, and for example, a plurality of components may be formed as a single member, a plurality of members may form a single component, a certain component may be part of another component, and part of a certain component may overlap with part of another component.

Further, while a plurality of procedures are described in a sequential order in the method and the computer program according to the present invention, the order of description does not limit the order in which the plurality of procedures are executed. Therefore, when the method and the computer program according to the present invention are implemented, the order of the plurality of procedures may be changed without affecting the contents.

Furthermore, a plurality of procedures in the method and the computer program according to the present invention are not limited to be executed at timings different from each other. Therefore, for example, a certain procedure may be executed during execution of another procedure, and an execution timing of a certain procedure and an execution timing of another procedure may overlap with each other in part or in whole.

### Advantageous Effects of Invention

Each of the aforementioned aspects can provide a technology enabling equipment requiring operation to be operated without touching the equipment by hand.

### BRIEF DESCRIPTION OF THE DRAWINGS

FIG. 1 is a diagram conceptually illustrating a system configuration of an information processing system according to an example embodiment of the present invention.

FIG. 2 is a block diagram illustrating a hardware configuration of a computer providing an equipment operation apparatus or a communication apparatus.

FIG. 3 is a functional block diagram logically illustrating a configuration of the equipment operation apparatus according to the example embodiment.

FIG. 4 is a functional block diagram logically illustrating a configuration of the communication apparatus according to the example embodiment.

FIG. 5 is a flowchart illustrating an operation example of the information processing system according to the example embodiment.

FIG. 6 is a functional block diagram illustrating a logical configuration example of an equipment operation apparatus according to an example embodiment.

FIG. 7 is a diagram for illustrating a first example of an operation screen on a mobile terminal of a user.

FIG. 8 is a diagram for illustrating a second example of an operation screen on the mobile terminal of the user.

FIG. 9 is a diagram illustrating an example of a data structure of a usage history.

FIG. 10 is a diagram illustrating an example of a data structure of floor number information.

### EXAMPLE EMBODIMENT

Example embodiments of the present invention will be described below by using drawings. Note that in every drawing, similar components are given similar signs, and description thereof is not included as appropriate. In every diagram below, a configuration of a part unrelated to the essence of the present invention is not included and is not illustrated.

In the example embodiments, “acquisition” includes at least either of an apparatus getting data or information stored in another apparatus or a storage medium (active acquisition), and an apparatus inputting data or information output from another apparatus to the apparatus (passive acquisition). Examples of the active acquisition include making a request or an inquiry to another apparatus and receiving a response, and readout by accessing another apparatus or a storage medium. Further, examples of the passive acquisition include reception of distributed (or, for example, transmitted or push notified) information. Furthermore, “acquisition” may refer to acquisition by selection from received data or information, or selective reception of distributed data or information.

### First Example Embodiment

### System Overview

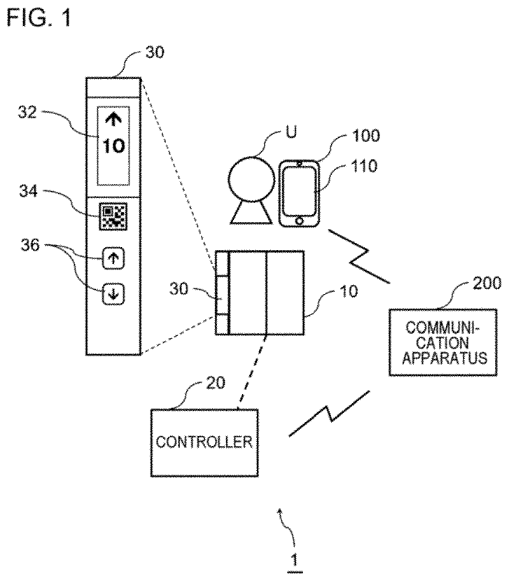

FIG. 1 is a diagram conceptually illustrating a system configuration of an information processing system 1 according to an example embodiment of the present invention. The information processing system 1 includes an equipment operation apparatus 100 and a communication apparatus 200.

For example, the equipment operation apparatus 100 is provided by a mobile terminal, such as a smartphone or a tablet terminal, carried by a user U, and the mobile terminal includes a computer 1000 to be described later. The equipment operation apparatus 100 is provided by installing an application enabling operation of an operated apparatus 10 on the mobile terminal (hereinafter also referred to as a mobile terminal 100) of the user U and causing a processor 1020 in the computer 1000 to execute the application. Thus, by using the mobile terminal 100, the user U can perform operation of the operated apparatus 10 without touching the apparatus by hand.

In another example, a function of the equipment operation apparatus 100 (a function of displaying an operation screen of the operated apparatus 10 and accepting an operation instruction from the user U) may be used on the mobile terminal 100 of the user U by activating a browser on the mobile terminal 100 and accessing a predetermined web page on the information processing system 1 through a network such as the Internet.

The operated apparatus 10 operated by operating an operation board by the user U poses a risk of becoming a source of an infectious disease due to the operation board being touched and operated by hand by unspecified persons. Then, the present example embodiment enables the user U to operate the operated apparatus 10 without touching the operation board of the operated apparatus 10 by hand by providing the equipment operation apparatus 100 by previously installing and executing an application on the mobile terminal 100 of the user U.

For example, the operated apparatus 10 is an elevator 10. The information processing system 1 enables use of the elevator 10 without touching, by hand, operation boards such as an outside operation panel 30 installed outside the elevator 10 and an inside operation panel installed inside the elevator 10. Other examples of the operated apparatus 10 include, but not limited to, various vending machines in a town, cooking appliances, such as a coffee maker and a microwave oven, a copying machine, and a printer that are installed at a convenience store, a drink dispenser at a restaurant, a ticket machine for various tickets such as a train ticket and a parking ticket, and a fare adjustment machine.

It is assumed that an operated apparatus 10 is preassigned with apparatus identification information for distinguishing operated apparatuses 10 from each other. When the operated apparatuses 10 include different types of apparatuses, the apparatus identification information further includes information allowing determination of the type of operated apparatus 10. For example, the apparatus identification information may be a combination of a predetermined number of digits of alphanumeric characters and symbols. The structure (such as the number of digits, and a combination of alphanumeric characters and symbols) of the apparatus identification information may vary depending on the type of apparatus.

Further, when a plurality of operated apparatuses 10 can be operated together, for example, when one outside operation panel 30 calls a plurality of elevators, a plurality of operated apparatuses 10 may be grouped and be determined by one piece of apparatus identification information. However, when an outside operation panel 30 is provided for each elevator and can individually call an elevator, different pieces of apparatus identification information are assigned in such a way that elevators can be individually determined. Further, as will be described later, an elevator as an operated apparatus 10 may be determined by calling a plurality of elevators by one outside operation panel 30 and then acquiring, for operating an elevator which a user has got into, apparatus identification information individually assigned to the elevator.

Specifically, individual apparatus identification information and apparatus (group) identification information for grouping and determining a plurality of operated apparatuses 10 can be assigned to one operated apparatus 10. Further, for example, apparatus identification information may be assigned in such a way that a plurality of elevators positioned in the same building and a plurality of elevators respectively positioned in a plurality of different buildings can be respectively determined. Apparatus identification information may be set as appropriate depending on the type of an operated apparatus 10 used by the user U, an installed location or an area, a management target area of a manager managing the operated apparatus 10, and the like.

The user U may perform user registration before using the information processing system 1. Note that user registration is not mandatory, and use as a visitor may also be possible. A configuration of using the information processing system 1 without performing user registration will be described in the first example embodiment.

The communication apparatus 200 communicates with a mobile terminal 100 (an example of the equipment operation apparatus 100) of the user U and also communicates with a controller 20 (a control unit) of the operated apparatus 10. The communication apparatus 200 receives an operation instruction to the operation apparatus 10 from the user U from the mobile terminal 100 and transfers the received operation instruction to the controller 20 of the operated apparatus 10. In other words, the communication apparatus 200 has a gateway function of relaying a communication between the mobile terminal 100 of the user U and the controller 20 of the operated apparatus 10.

### Hardware Configuration Example

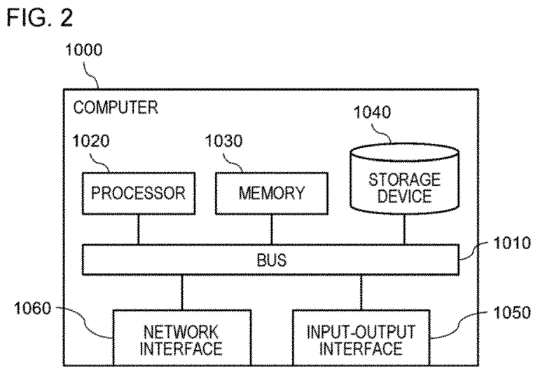

FIG. 2 is a block diagram illustrating a hardware configuration of a computer 1000 providing the equipment operation apparatus 100 or the communication apparatus 200 to be described later. The controller 20 of the elevator 10 in FIG. 1 is also provided by the computer 1000.

The computer 1000 includes a bus 1010, a processor 1020, a memory 1030, a storage device 1040, an input-output interface 1050, and a network interface 1060.

The bus 1010 is a data transmission channel for the processor 1020, the memory 1030, the storage device 1040, the input-output interface 1050, and the network interface 1060 to transmit and receive data to and from one another. Note that the method for interconnecting the processor 1020 and other components is not limited to a bus connection.

The processor 1020 is a processor provided by a central processing unit (CPU), a graphics processing unit (GPU), or the like.

The memory 1030 is a main storage provided by a random-access memory (RAM) or the like.

The storage device 1040 is an auxiliary storage provided by a hard disk drive (HDD), a solid-state drive (SSD), a memory card, a read-only memory (ROM), or the like. The storage device 1040 stores program modules providing the functions of the equipment operation apparatus 100 (such as a connection unit 102, a display processing unit 104, and a transmission unit 106, or a first communication unit 202, a second communication unit 204, a reception unit 206, a first transmission unit 208, and a second transmission unit 210 in the communication apparatus 200, to be described later). By reading each program module into the memory 1030 and executing the program module by the processor 1020, each function related to the program module is provided. Further, the storage device 1040 may also store data in a storage unit 130 in the equipment operation apparatus 100 and a storage unit 230 in the communication apparatus 200, to be described later.

A program module may be recorded on a storage medium. The storage medium on which the program module is recorded includes a non-transitory tangible medium usable by the computer 1000; and a program code readable by the computer 1000 (processor 1020) may be embedded in the medium.

The input-output interface 1050 is an interface for connecting the computer 1000 to various types of input-output equipment. The input-output interface 1050 also functions as a communication interface performing short-distance wireless communication such as Bluetooth (registered trademark) and/or near field communication (NFC).

The network interface 1060 is an interface for connecting the computer 1000 to a communication network. Examples of the communication network include a local area network (LAN) and a wide area network (WAN). The method for connecting the network interface 1060 to the communication network may be a wireless connection or a wired connection.

Then, the computer 1000 is connected to required equipment [such as a touch panel on the mobile terminal 100 (an example of a display unit 110 to be described later) and/or a camera] through the input-output interface 1050 or the network interface 1060.

### Functional Configuration Example

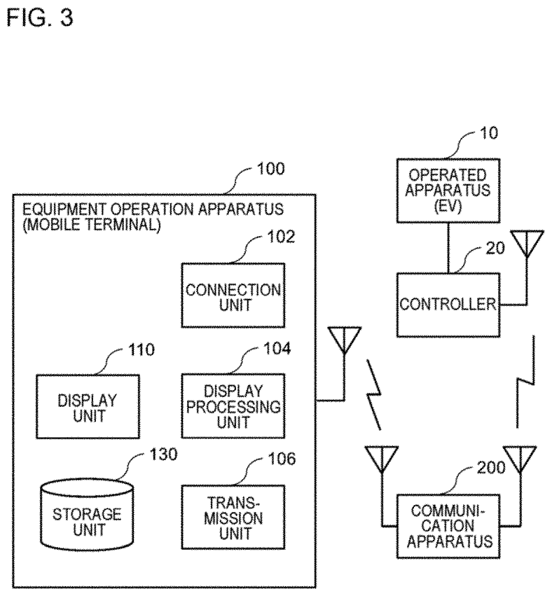

FIG. 3 is a functional block diagram logically illustrating a configuration of the equipment operation apparatus 100 according to the present example embodiment. The equipment operation apparatus 100 includes the connection unit 102, the display processing unit 104, and the transmission unit 106.

The connection unit 102 acquires apparatus identification information for distinguishing a plurality of operated apparatuses 10 from each other and connects to a communication apparatus 200 communicable with a controller 20 of an operated apparatus 10 indicated by the apparatus identification information.

When a connection to the communication apparatus 200 is established, the display processing unit 104 causes the display unit 110 (such as the touch panel on the mobile terminal 100) to display an operation screen for operating the operated apparatus 10 controlled by the controller 20 communicable with the communication apparatus 200.

The transmission unit 106 transmits an operation instruction input by operating the operation screen to the communication apparatus 200 and causes the operation instruction to be transferred to the controller 20 of the operated apparatus 10.

Examples of the display unit 110 include a liquid crystal display and an organic electro-luminescence (EL) display. The display unit 110 in the example in the present example embodiment is a touch panel on the mobile terminal 100 of the user U and also serves as an operation acceptance unit accepting operation by the user U on a displayed operation screen.

The equipment operation apparatus 100 further includes the storage unit 130. The storage unit 130 may be an apparatus separate from the equipment operation apparatus 100, may be an apparatus included in the equipment operation apparatus 100, or may be a combination of the two.

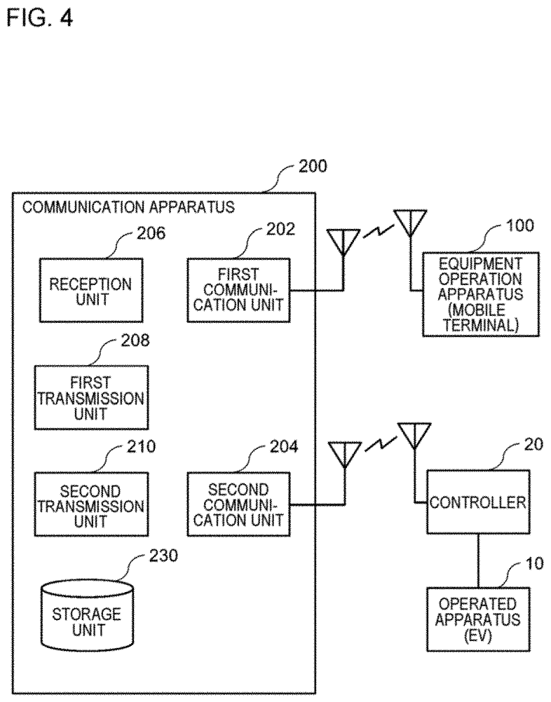

FIG. 4 is a functional block diagram logically illustrating a configuration of the communication apparatus 200 according to the present example embodiment. The communication apparatus 200 includes the first communication unit 202, the second communication unit 204, the reception unit 206, the first transmission unit 208, and the second transmission unit 210.

The first communication unit 202 wirelessly communicates with a mobile terminal 100 (an example of the equipment operation apparatus 100) of the user U. The first communication unit 202 according to the present example embodiment communicates with the mobile terminal 100 by a wireless communication method conforming to the Bluetooth (registered trademark) standard.

The second communication unit 204 communicates with controllers 20 of a plurality of operated apparatuses 10. The second communication unit 204 communicates by a method related to a communication method of a controller 20. Specifically, the communication apparatus 200 is configured to include the network interface 1060 or the input-output interface 1050 related to the communication method of the controller 20.

When a connection to the mobile terminal 100 of the user U is established through the first communication unit 202, the reception unit 206 receives, from the mobile terminal 100 of the user U, apparatus identification information for distinguishing a plurality of operated apparatuses 10 from each other.

Based on the received apparatus identification information, the first transmission unit 208 transmits information for causing the display unit 110 in the mobile terminal 100 of the user U to display an operation screen for operating the operated apparatus 10 to the mobile terminal 100 of the user U through the first communication unit 202.

When receiving an operation instruction from the mobile terminal 100 of the user U to the operated apparatus 10 through the first communication unit 202, the second transmission unit 210 transmits the operation instruction to the controller 20 of the operated apparatus 10 through the second communication unit 204.

The communication apparatus 200 further includes the storage unit 230. The storage unit 230 may be an apparatus separate from the communication apparatus 200, may be an apparatus included in the communication apparatus 200, or may be a combination of the two.

The display processing unit 104 in the equipment operation apparatus 100 causes the display unit 110 in the mobile terminal 100 to display an operation menu and the like by executing an application installed on the mobile terminal 100. Specifically, the display processing unit 104 causes the display unit 110 to display a standard operation screen unrelated to the type of operated apparatus 10 and the operating status of the operated apparatus 10. Then, when receiving, from the communication apparatus 200, information for causing a screen based on the type of operated apparatus 10 and/or the operating status of the operated apparatus 10 to be displayed from the communication apparatus 200, the display processing unit 104 causes the display unit 110 to display a screen based on the type of operated apparatus 10 and/or the operating status of the operated apparatus 10, based on the received information.

On the other hand, the first transmission unit 208 in the communication apparatus 200 is responsible for a function of transmitting, to the equipment operation apparatus 100, information for causing the display unit 110 in the equipment operation apparatus 100 to display an operation screen related to the type of operated apparatus 10 and/or the operating status of the operated apparatus 10.

For example, when the operated apparatus 10 is an elevator, the first transmission unit 208 in the communication apparatus 200 transmits, to the equipment operation apparatus 100, information for causing the display unit 110 in the equipment operation apparatus 100 to display an operation screen for operating the elevator. Note that the application installed on the mobile terminal 100 may be prepared for each type of operated apparatus 10. Therefore, when an application dedicated to operation of the elevator is installed on the mobile terminal 100, the display processing unit 104 in the mobile terminal 100 may cause the display unit 110 to display a screen for elevator operation instead of receiving information for screen display from the communication apparatus 200. Note that information for the display processing unit 104 to perform screen display based on the status of the operated apparatus 10 may be received from the communication apparatus 200.

For example, as for an elevator, floor numbers to which the elevator is movable vary by apparatus or are predetermined. Accordingly, a display of a button for specifying a floor number displayed on an operation screen of an elevator varies by elevator (operated apparatus 10). Then, floor number information indicating floor numbers to which an elevator is movable is stored in the storage unit 230 in association with apparatus identification information.

When a connection between the equipment operation apparatus 100 and the communication apparatus 200 is established, the first transmission unit 208 transmits floor number information stored in the storage unit 230 to the equipment operation apparatus 100 through the first communication unit 202. Then, based on floor numbers to which an elevator is movable indicated by the received floor number information, the display processing unit 104 causes the display unit 110 to display a floor number specification screen in which floor number specification buttons for specifying a floor number of a destination of the elevator is placed. For example, when the storage unit 230 stores that the elevator is movable from the first floor to the tenth floor as floor number information, the display processing unit 104 causes the operation screen to display 10 floor number buttons for specifying the first floor to the tenth floor.

Furthermore, the first transmission unit 208 in the communication apparatus 200 may transmit, to the equipment operation apparatus 100 through the first communication unit 202, information for causing the display unit 110 in the mobile terminal 100 to display the current status of the elevator, such as information indicating that the elevator is currently moving to the floor where the user U is located and information indicating the floor number where the elevator is currently located. The display processing unit 104 in the equipment operation apparatus 100 can receive the information from the communication apparatus 200 and cause the display unit 110 to display the information on the screen as information indicating the current state of the elevator.

Each component in the equipment operation apparatus 100 or the communication apparatus 200 in FIG. 3 or FIG. 4 is provided by any combination of hardware and software of the computer 1000 in FIG. 2. Then, it should be understood by a person skilled in the art that various modifications to the providing method and the apparatus can be made. A functional block diagram illustrating the equipment operation apparatus 100 or the communication apparatus 200 according to each example embodiment represents logical function-based blocks rather than a hardware-based configuration.

### Operation Example

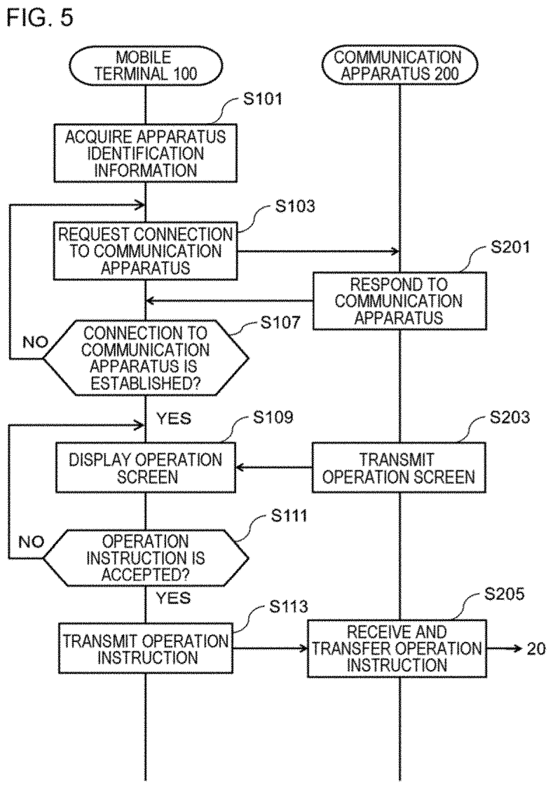

FIG. 5 is a flowchart illustrating an operation example of the information processing system 1 according to the present example embodiment.

In the equipment operation apparatus 100, the connection unit 102 acquires apparatus identification information (Step S101).

Various methods for acquiring apparatus identification information are considered, examples of which include the following but not being limited thereto.

(1) A QR code (registered trademark) in which apparatus identification information of an operated apparatus 10 is recorded is provided in association with the operated apparatus 10. Note that the apparatus identification information is not limited to be recorded in a QR code and may be recorded in a barcode.

For example, the QR code may be stuck to the operated apparatus 10 itself or an area around the operated apparatus 10 or may be displayed on a display. Alternatively, the apparatus identification information of the operated apparatus 10 may be recorded in a QR code printed on a medium such as a flier or an advertisement related to a facility where the operated apparatus 10 is installed. An image of the QR code is captured by using the mobile terminal 100 of the user U, and the apparatus identification information recorded in the QR code is read by a predetermined application.

For example, when the operated apparatus 10 is a drink dispenser at a family restaurant, a QR code printed on a menu or a tabletop POP may be read, and operation identification information of the drink dispenser may be acquired. A configuration of acquiring apparatus identification information from a QR code will be described in detail in the second example embodiment.

(2) Apparatus identification information of an operated apparatus 10 is recorded in an IC memory provided inside or around the operated apparatus 10. By using the mobile terminal 100 of the user U, the apparatus identification information is read from the IC memory provided inside or around the elevator 10 by NFC.

(3) Apparatus identification information of an operated apparatus 10 daily used by the user U is previously stored in the storage unit 130 in the mobile terminal 100 of the user U. For example, apparatus identification information of an elevator 10 or a delivery box of a home apartment of the user U may be previously stored. When apparatus identification information of a plurality of different operated apparatuses 10 is registered in the storage unit 130 in the mobile terminal 100 of the user U, the user U may be able to select an apparatus through a menu screen for selecting an operated apparatus 10 to be operated.

Compared with the configuration in aforementioned (2), the configurations in aforementioned (1) and (3) do not require introduction of an IC memory or the like conforming to NFC when the information processing system 1 is newly introduced. A QR code or the like has only to be stuck to or placed on an operated apparatus 10 or an area around the operated apparatus 10, and therefore costs can be kept low. As will be described later, information required for connection to the communication apparatus 200, such as a universally unique identifier (UUID), is recorded in a QR code along with apparatus identification information.

Returning to FIG. 5, the connection unit 102 attempts to connect to the communication apparatus 200 installed near the elevator 10 by using the acquired apparatus identification information and the acquired UUID (Step S103). The connection unit 102 according to the present example embodiment makes a connection request for a Bluetooth (registered trademark) communication. While the connection unit 102 uses a connection method using the UUID acquired along with the apparatus identification information without performing pairing with communication target equipment in this example, the method is not limited thereto. For example, when the operated apparatus 10 being an operation target, such as the elevator 10 in the home apartment, is an apparatus for daily use by the user U, the equipment operation apparatus 100 and the communication apparatus 200 may be configured to be paired and connected by a Bluetooth communication before use of the apparatuses starts. In the communication apparatus 200, the first communication unit 202 responds to the connection request from the mobile terminal 100 of the user U (Step S201).

When confirming establishment of a connection to the communication apparatus 200 (YES in Step S107), the first transmission unit 208 in the communication apparatus 200 transmits, to the mobile terminal 100 through the first communication unit 202, information for causing the display unit 110 in the mobile terminal 100 of the user U to display an operation screen for operating the operated apparatus 10, based on the apparatus identification information received from the mobile terminal 100 (Step S203). The display processing unit 104 causes the display unit 110 (such as the touch panel on the mobile terminal 100 of the user U) to display the operation screen for operating the operated apparatus 10 (controller 20), based on the information received from the communication apparatus 200 (Step S109).

Authentication processing does not need to be included in the connection establishment with the communication apparatus 200 in Step S107, and a connection in a communication between the mobile terminal 100 and the communication apparatus 200 has only to be confirmed.

In the mobile terminal 100, when operation by the user U is accepted on the operation screen (YES in Step S111), the transmission unit 106 transmits an operation instruction input by the operation on the operation screen to the communication apparatus 200 (Step S113) and causes the operation instruction to be transferred from the communication apparatus 200 to the controller 20 of the operated apparatus 10 (Step S205). When receiving the operation instruction, the controller 20 controls the operated apparatus 10 in accordance with the instruction (unillustrated).

In the equipment operation apparatus 100 according to the present example embodiment, the connection unit 102 acquires apparatus identification information and connects to a communication apparatus 200 communicable with the controller 20 of an operated apparatus 10 indicated by the acquired apparatus identification information. Then, when a connection to the communication apparatus 200 is established, the display processing unit 104 causes the display unit 110 to display an operation screen for operating the operated apparatus 10 controlled by the controller 20 communicable with the communication apparatus 200. Each of the aforementioned units in the equipment operation apparatus 100 can be provided by installing and activating an application on the mobile terminal 100 of the user U. Thus, when acquiring apparatus identification information by the mobile terminal 100, the user U can cause the display unit 110 to display an operation screen of the operated apparatus 10 and therefore can operate the operated apparatus 10 without touching the apparatus by hand, according to the present example embodiment.

The user U does not need to touch an operation board in an operated apparatus 10 that may be operated by many and unspecified persons, and therefore a risk of contracting an infectious disease through the operation board can be reduced.

For example, before getting into an elevator 10, the user U acquires apparatus identification information by using the mobile terminal 100, connects to the communication apparatus 200 by using the acquired apparatus identification information, and receives information for displaying an operation screen of the elevator 10 from the communication apparatus 200. For example, when the elevator 10 is movable from the first floor to the tenth floor, 10 destination floor specification buttons for the first floor to the tenth floor are displayed on the operation screen on the mobile terminal 100. Then, when the user U operates a destination floor specification button on the operation screen on the mobile terminal 100, the floor number specified by the user U is transmitted from the mobile terminal 100 to the controller 20 through the communication apparatus 200, and the controller 20 can perform control in such a way as to move the elevator 10 to the specified floor number.

### Second Example Embodiment

### Functional Configuration Example

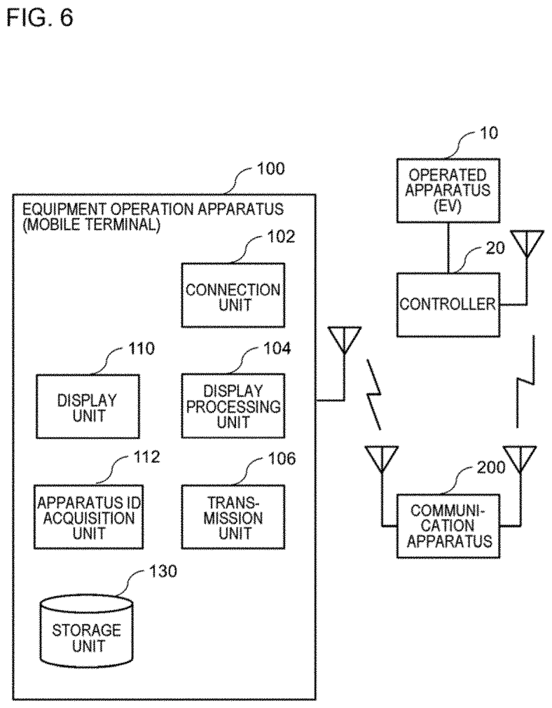

FIG. 6 is a functional block diagram illustrating a logical configuration example of an equipment operation apparatus 100 according to the present example embodiment. The present example embodiment is similar to the aforementioned example embodiment except for having a configuration in which an operated apparatus 10 is an elevator, and the equipment operation apparatus 100 acquires apparatus identification information by reading a two-dimensional code such as a QR code (registered trademark). The equipment operation apparatus 100 further includes an apparatus identification number acquisition unit 112 in addition to the configuration of the equipment operation apparatus 100 in FIG. 3. Note that the configuration according to the present example embodiment may be combined with at least one of other example embodiments without contradicting each other.

The apparatus identification number acquisition unit 112 acquires apparatus identification information by a user U reading a two-dimensional code (such as a QR code) provided at an entrance or an elevator hall of a building having an elevator.

As described above, after apparatus identification information is transmitted to a communication apparatus 200 and a connection between the equipment operation apparatus 100 and the communication apparatus 200 is established, an operation screen for operating an operated apparatus 10 is displayed on a display unit 110 in the equipment operation apparatus 100 by a display processing unit 104. While the following two examples are considered as a method of displaying the operation screen, the method is not limited thereto.

### Operation Example 1

The display processing unit 104 causes the display unit 110 to display at first a destination specification screen for specifying a destination of the elevator 10. In this example, by reading a QR code once outside the elevator 10, the user U can call the elevator to the floor where the user U is currently located, perform specification operation of a destination on the destination specification screen displayed on the mobile terminal 100, and raise or lower the elevator to the destination floor. For example, a “destination” is a floor number of a floor being a destination of the elevator 10; however, a “destination” is not limited to a “floor number.” A “destination” may be the name of a floor such as “front” and “parking lot A.”

### Operation Example 2

The display processing unit 104 causes the display unit 110 to display at first a screen for specifying a moving direction of the elevator 10. Subsequently, when the apparatus identification number acquisition unit 112 acquires a two-dimensional code in the elevator, the display processing unit 104 causes the display unit 110 to display a floor number specification screen for specifying a floor number of a destination of the elevator 10. In this example, after reading a QR code outside the elevator and calling the elevator, the user U gets into the arriving elevator and further reads a QR code also in the elevator; and the user U can perform specification operation of a destination floor on the operation screen by using the mobile terminal 100 and raise or lower the elevator to the destination floor.

An operation will be described in detail below for each operation example.

### Operation Example 1

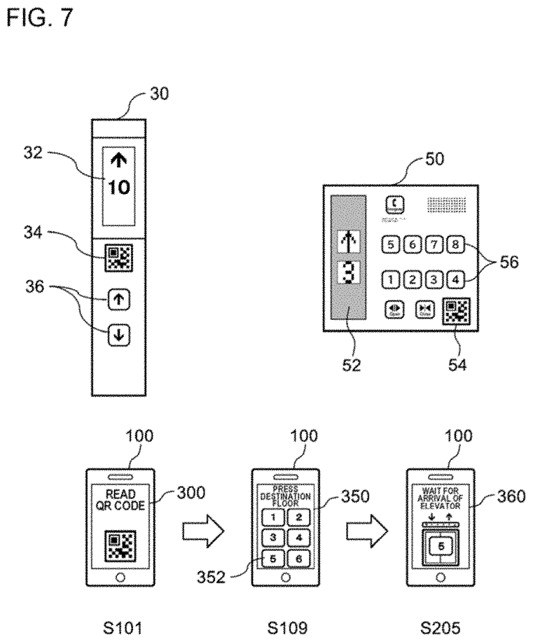

FIG. 7 is a diagram for illustrating an operation screen example on the mobile terminal 100 of the user U in the operation example 1. The example will be described below along the flowchart in FIG. 5.

First, when an application providing the equipment operation apparatus 100 is installed on the mobile terminal 100 of the user U and the application is activated, a code readout screen 300 is displayed on the mobile terminal 100 of the user U. The user U reads a QR code 34 stuck to an outside operation panel 30 of the elevator 10 by using the mobile terminal 100 (an example of the equipment operation apparatus 100). The apparatus identification number acquisition unit 112 acquires apparatus identification information of the elevator 10 and a UUID required for connection to a communication apparatus 200 from the QR code 34 (Step S101).

The connection unit 102 attempts to connect to the communication apparatus 200 installed near the elevator 10 by using the acquired apparatus identification information and the acquired UUID (Step S103). In the communication apparatus 200, the first communication unit 202 responds to a connection request from the mobile terminal 100 of the user U (Step S201). When confirming establishment of a connection to the communication apparatus 200 (YES in Step S107), the display processing unit 104 causes the display unit 110 (such as a touch panel on the mobile terminal 100 of the user U) to display a destination floor specification screen 350 (an example of the operation screen) for operating the elevator 10 (controller 20) (Step S109).

Further, the controller 20 needs to determine a floor number where the user U is currently located and move the elevator 10 to the floor. Information indicating the floor from which the user U has called the elevator 10 may be recorded in the QR code 34 along with apparatus identification information. For example, a floor number may be indicated by a predetermined number of digits (such as two digits) at predetermined positions, such as lowest or highest, in apparatus type identification information with a predetermined number of digits (such as 10 digits). The apparatus identification number acquisition unit 112 may further acquire information indicating a floor number from which the user U has called the elevator 10 from the QR code 34. The information is transmitted to the communication apparatus 200, and the communication apparatus 200 transfers the information to the controller 20. Thus, the controller 20 can determine the floor number where the user U is currently located, that is, the floor to which the elevator 10 is to be moved.

Alternatively, the communication apparatus 200 may be provided in each floor. In that case, a communication apparatus 200 a connection between which and the mobile terminal 100 of the user U is established may transmit information indicating a floor number where the communication apparatus 200 is installed to the controller 20 as information indicating a floor number from which the user U has called the elevator 10.

It is assumed here that the user U depresses a floor number specification button 352 for the fifth floor on the destination floor specification screen 350. When accepting the floor number specification (fifth floor) by the user U on the destination floor specification screen 350 (YES in Step S111), the transmission unit 106 transmits the floor number specification (fifth floor) to the communication apparatus 200 (Step S113) and causes the floor number specification (fifth floor) to be transferred from the communication apparatus 200 to the controller 20 (Step S205). When receiving the floor number specification (fifth floor), the controller 20 controls the operated apparatus 10 in accordance with the instruction (unillustrated). Specifically, the controller 20 raises or lowers the elevator 10 to the fifth floor.

The communication apparatus 200 receives, from the controller 20, information indicating that the operated apparatus 10 is moving to the fifth floor specified as the destination, and by transferring the information to the mobile terminal 100 of the user U, the display processing unit 104 can cause the display unit 110 to display a destination arrival standby screen 360.

For example, in some cases, when a destination floor specification button 56 on an inside operation panel 50 of the elevator 10 is depressed, a user of the elevator 10 receives notification by lighting of a destination floor specification button 56 or display of a destination floor by a display unit. Thus, there is a risk of another person other than the person himself or herself becoming aware of the destination floor. In the communication apparatus 200 according to the present example embodiment, a second transmission unit 210 may transmit, to the controller 20 of the elevator 10, an instruction not to cause information (destination floor) indicating a specification instruction of a destination floor specified by the user U to be displayed on the destination floor specification button 56 on the inside operation panel 50 of the elevator 10, along with the specification instruction of the destination floor on the destination floor specification screen 350.

Instructions not to cause display may include an instruction not to transmit, from the controller 20 to the inside operation panel 50, an instruction to cause a destination floor specified by the user U to be displayed in accordance with an instruction from the user U. Furthermore, instructions not to cause display may include an instruction not to cause a destination floor specified by the user U to be displayed in accordance with an instruction from the user U, an instruction to cause the destination floor to be displayed when a destination floor specification button 56 is depressed by a user other than the user U, and an instruction not to change, when a destination floor specification button 56 related to the same destination floor is depressed by another user before the user U, a state displayed by the depression of the destination floor specification button 56.

Thus, lighting of a destination floor specification button 56 for a destination floor of the user U or display of the destination floor on the inside operation panel 50 of the elevator 10 does not occur, and therefore another person in the elevator 10 does not become aware of the destination floor of the user U.

Further, the same applies to the outside operation panel 30. In some cases, when an up button 322 or a down button 324 on the outside operation panel 30 is depressed by the user U, the button depressed by the user U is notified to a user of the elevator 10 by lighting of the button or display on a display unit. Thus, there is a risk of another person other than the person himself or herself becoming aware of whether the destination is up or down. In the communication apparatus 200 according to the present example embodiment, the second transmission unit 210 transmits, to the controller 20 of the elevator 10, along with an operation instruction indicating which of the up button 322 and the down button 324 on the outside operation panel 30 is depressed by the user U, an instruction not to cause information indicating an instruction specified by the user U (information indicating the direction of movement, that is, up or down) to be displayed on the outside operation panel 30 of the elevator 10.

Instructions not to cause display may include an instruction not to transmit, from the controller 20 to the outside operation panel 30, an instruction to cause information indicating an instruction specified by the user U to be displayed in accordance with an instruction from the user U. Furthermore, instructions not to cause display may include an instruction not to cause information indicating an instruction specified by the user U to be displayed in accordance with an instruction from the user U, an instruction to cause the information to be displayed when an up-down specification button 36 is depressed by a user other than the user U, and an instruction not to change, when the same up-down specification button 36 is depressed by a user other than the user U, a state displayed by the depression of the up-down specification button 36.

Thus, information indicating whether the user U is moving up or down is not displayed on the outside operation panel 30 of the elevator 10 as well, and therefore another user in the elevator 10 does not become aware of the moving direction of the user U.

### Operation Example 2

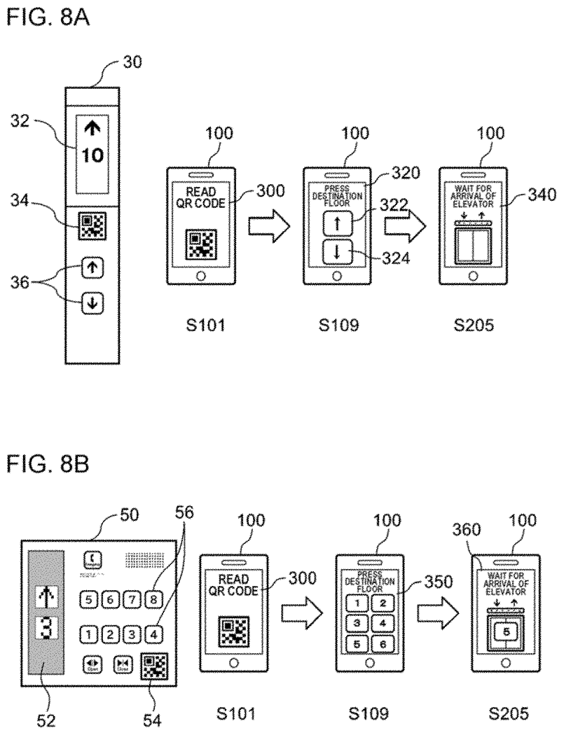

FIG. 8 is a diagram for illustrating an operation screen example on the mobile terminal 100 of the user U in the operation example 2. The example will be described below along the flowchart in FIG. 5. FIG. 8A illustrates an operation screen example when a QR code 34 on the outside operation panel 30 is read, and FIG. 8B illustrates an operation screen example when a QR code 54 on the inside operation panel 50 is read.

First, Step S101 to Step S201 in FIG. 5 are the same as those in the operation example 1. Then, when confirming establishment of a connection to the communication apparatus 200 (YES in Step S107), the display processing unit 104 causes the display unit 110 (such as the touch panel on the mobile terminal 100 of the user U) to display an up-down specification screen 320 (an example of the operation screen) for operating the elevator 10 (controller 20) (Step S109). In the example in FIG. 8A, the up-down specification screen 320 includes an up button 322 and a down button 324.

When accepting operation on the up-down specification screen 320 by the user U (YES in Step S111), the transmission unit 106 transmits an operation instruction input by operating the up-down specification screen 320 to the communication apparatus 200 (Step S113). It is assumed here that the user U depresses the up button 322. Similarly to the aforementioned example, the transmission unit 106 transmits information indicating a floor number where the user U is currently located and information indicating depression of the up button 322 to the controller 20 (Step S113) and causes the information to be transferred from the communication apparatus 200 to the controller 20 of the elevator 10 (Step S205).

When receiving the information, the controller 20 moves the elevator 10 to a location where the user U is currently located. At this time, when the controller 20 controls a plurality of elevators 10, the controller 20 can determine an elevator 10 to be moved to the floor where the user U is currently located, based on an up-down state of the elevator 10 and information about which of the up button 322 and the down button 324 is depressed by the user U, and move the elevator. A method for controlling the elevator 10 by the controller 20 is determined by a program of the controller 20, and the equipment operation apparatus 100 according to the present invention does not need to be involved in specifics of the control.

While the controller 20 is moving the elevator 10, the first transmission unit 208 in the communication apparatus 200 transmits information for causing the mobile terminal 100 of the user U to display an apparatus arrival standby screen 340 in FIG. 8A to the mobile terminal 100 through the first communication unit 202. The display processing unit 104 in the mobile terminal 100 causes the display unit 110 to display the apparatus arrival standby screen 340 in FIG. 8A, based on the received information and notifies the user U that the elevator 10 is on the move.

Then, the elevator 10 arrives at the floor where the user U awaits the elevator 10, and the user U gets into the elevator 10 and reads a QR code 54 stuck to the inside operation panel 50 in the elevator 10 in FIG. 8B. The apparatus identification number acquisition unit 112 acquires apparatus identification information and a UUID of the elevator 10 from the QR code 34 (Step S101).

The connection unit 102 attempts to connect to the communication apparatus 200 installed near the elevator 10 by using the acquired apparatus identification information and the acquired UUID (Step S103). In the communication apparatus 200, the first communication unit 202 responds to a connection request from the mobile terminal 100 of the user U (Step S201). When confirming establishment of a connection to the communication apparatus 200 (YES in Step S107), the display processing unit 104 causes the display unit 110 (such as the touch panel on the mobile terminal 100 of the user U) to display a destination floor specification screen 350 (an example of the operation screen) for operating the elevator 10 (controller 20) (Step S109).

In the example in FIG. 8B, Step S103 to Step S107 may be not included when the mobile terminal 100 has already established a connection of the communication apparatus 200. For example, when another person calls the elevator 10 and the user U gets into the elevator 10 without reading the QR code 34 on the outside operation panel 30, a connection to the communication apparatus 200 can be established by executing Step S103 to Step S107. Then, the user U can specify a destination floor by operating the destination floor specification screen 350 in this example as well, similarly to the operation example 1.

At this time, based on the apparatus identification information acquired from the QR code 54 on the inside operation panel 50, the first transmission unit 208 transmits floor number information of the elevator in the apparatus identification information to the equipment operation apparatus 100 through the first communication unit 202. Specifically, the first transmission unit 208 transmits floor number information indicating floor numbers to which the elevator is movable to the mobile terminal 100 and causes the display processing unit 104 in the mobile terminal 100 to display floor number specification buttons 352 for specifying a destination floor of the elevator 10 on the destination floor specification screen 350, based on the floor number information. For example, when the elevator 10 is movable from the first floor to the fifth floor, the first transmission unit 208 transmits information for causing the destination floor specification screen 350 to display five floor number specification buttons 352 for specifying the first floor to the fifth floor to the mobile terminal 100 through the first communication unit 202.

The apparatus identification number acquisition unit 112 according to the present example embodiment acquires apparatus identification information of the elevator 10 by reading a QR code. The QR code may include the apparatus identification information and a UUID required for connection to the communication apparatus 200. The mobile terminal 100 can connect to the communication apparatus 200 by using the apparatus identification information and the UUID.

Further, the present example embodiment provides effects similar to those of the aforementioned example embodiment and is configured not to reflect specifics of operation by the mobile terminal 100, such as a destination floor of the elevator 10, in lighting of the destination floor specification button 56 on the inside operation panel 50, and therefore another person does not become aware of specifics of operation (such as a destination floor) by the user U.

### Third Example Embodiment

A mobile terminal 100 according to the present example embodiment differs from the aforementioned first and second example embodiments in having a configuration in which user identification information (such as a phone number) allowing determination of a user U using the mobile terminal 100 is transmitted to a communication apparatus 200. In other words, a transmission unit 106 operates differently. The present example embodiment will be described below by using the functional block diagram of the equipment operation apparatus 100 in FIG. 3 and the functional block diagram of the communication apparatus 200 in FIG. 4 according to the first example embodiment. Note that the equipment operation apparatus 100 and the communication apparatus 200 according to the present example embodiment may be combined with at least one of the configurations of other example embodiments without contradicting each other.

The transmission unit 106 in the equipment operation apparatus 100 transmits user identification information allowing determination of a user who uses the mobile terminal 100 to the communication apparatus 200.

The equipment operation apparatus 100 according to the present example embodiment is the mobile terminal 100 used by the user U. For example, the mobile terminal 100 is assigned with a phone number, and the phone number is user identification information allowing determination of the user U.

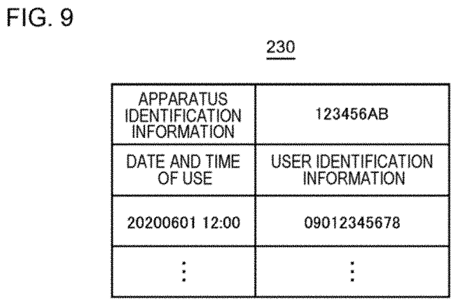

The communication apparatus 200 receives user identification information from the equipment operation apparatus 100 and records the information into a storage unit 230 as usage history information (FIG. 9). The information may be transmitted from the communication apparatus 200 to an unillustrated management server and be stored and managed in the management server. The management server is also provided by the computer 1000 in FIG. 2.

When the user U previously performs user registration and uses the information processing system 1, by previously registering user identification information in the management server, the communication apparatus 200 may inquire of the management server about a determination result of whether acquired user identification information is user registered. For example, the communication apparatus 200 may restrict specifics of operation that can be performed on an operated apparatus 10 by distinguishing between a user-registered user and a non-user-registered user. For example, the communication apparatus 200 may place restrictions such as allowing a mobile terminal 100 of a user-registered user U to specify a security-enhanced floor as a destination but not allowing a mobile terminal 100 of a non-user-registered user U to specify such a floor.

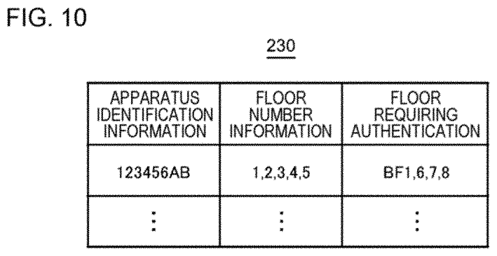

Specifically, when the operated apparatus 10 is an elevator, the aforementioned storage unit 230 stores floor number information including information about a specific floor (such as a security-enhanced floor) requiring input of authentication information in order to be specified as a destination of the elevator. FIG. 10 is a diagram illustrating an example of a data structure of floor number information stored in the storage unit 230.

A first transmission unit 208 reads floor number information of the elevator being the operated apparatus 10 from the storage unit 230 and transmits, through a first communication unit 202, the information to the equipment operation apparatus 100 a connection between which and the communication apparatus 200 is established. A display processing unit 104 causes a destination floor specification screen 350 to display nine floor number specification buttons 352 for specifying at least one of the first floor below the ground to the eighth floor on the ground, based on the received floor number information.

When a specific floor requiring authentication is specified on the destination floor specification screen 350 as a destination by the user U, in other words, when one of floor number specification buttons 352 for destination floors being the first floor below the ground and the sixth floor to the eighth floor on the ground is depressed, the display processing unit 104 causes a display unit 110 to display an input screen (unillustrated) of authentication information. The authentication information is a personal identification number or the like required for moving to a specific floor.

The authentication information may be set between an administration department of the elevator 10 or a building in which the elevator 10 is installed, and the user U and therefore does not need to be managed by the information processing system 1. In the information processing system 1, determination of necessity to input authentication information and input of the authentication information may be performed by using the mobile terminal 100 of the user U instead of an operation board installed in the building, and input authentication information may be transmitted from the equipment operation apparatus 100 to the controller 20 through the communication apparatus 200. Determination of whether authentication information is required and determination of whether entry is permitted may be performed by the controller 20 or another security surveillance means.

The transmission unit 106 transmits authentication information input on an authentication information input screen 380 to the communication apparatus 200. The communication apparatus 200 transfers the received authentication information to the controller 20. Note that the destination of the authentication information is not limited to the controller 20. For example, the authentication information may be transmitted to an unillustrated authentication server through the communication apparatus 200.

Alternatively, in the example in FIG. 7, the display processing unit 104 may cause the display unit 110 to display the authentication information input screen after a QR code 34 on an outside operation panel 30 is read on a code readout screen 300 and before the destination floor specification screen 350 is displayed. Furthermore, a QR code in which apparatus identification information of the elevator 10 is recorded may be stuck to an operation panel of an admission interphone; and when the QR code is read upon entry into a building where the elevator 10 is positioned, a connection unit 102 may connect to the communication apparatus 200. Then, the display processing unit 104 may cause the display unit 110 to display an operation screen on the operation panel of the admission interphone, and the user U may input a personal identification number for admission by operating the mobile terminal 100.

After authentication is performed and entry is permitted, the display processing unit 104 may display the operation screen of the elevator 10 without reading a QR code stuck to the outside operation panel 30 of the elevator 10. The personal identification number input upon entry may be used as-is as authentication information input of which is required when moving to a specific floor by the elevator 10.

Further, the transmission unit 106 may transmit the input authentication information to the communication apparatus 200 and cause an operation screen displayed on the display unit 110 in the mobile terminal 100 to be changed depending on the authentication result. For example, the first transmission unit 208 in the communication apparatus 200 may transmit information for displaying a destination floor specification screen 350 allowing specification of a security-enhanced floor as a destination to a mobile terminal 100 of an authenticated user U and may transmit information for displaying a destination floor specification screen 350 not including a security-enhanced floor as a destination to mobile terminals 100 of a user U failing authentication and a user U not inputting authentication information.

Further, authentication information may be previously stored in a storage unit 130 in the mobile terminal 100 of the user U. In this case, the transmission unit 106 may transmit, from the equipment operation apparatus 100 to the communication apparatus 200, the authentication information stored in the storage unit 130 automatically or upon acceptance of a transmission instruction from depression of an operation button without displaying an authentication information input screen on the display unit 110. For example, when a home apartment is on a specific floor and entry requires input of a personal identification number, the transmission unit 106 may read the personal identification number from the storage unit 130 and transmit the number to the communication apparatus 200 without inputting the personal identification number every time.

Furthermore, biometric authentication processing using a fingerprint, the face, or the like of the user U may be performed by using the mobile terminal 100 before reading the personal identification number from the storage unit 130, and readout of the personal identification number may be permitted when the authentication is successful. The biometric authentication processing may be diverted from a function of an operating system (OS) of the mobile terminal 100. In other words, a biometric authentication function used for personal identification when the user U uses the mobile terminal 100 may be used.

According to the present example embodiment, when a floor requiring authentication is specified as a destination on an operation screen of the mobile terminal 100 by the user U, the display processing unit 104 further displays an input screen prompting input of authentication information on the display unit 110, and therefore a security-enhanced floor can be specified by operating the mobile terminal 100. Furthermore, authentication information may be stored in the mobile terminal 100, and the recognition information may be transmitted to the controller 20 through the communication apparatus 200 without input operation; and therefore time and effort for input can be saved and a risk of another person stealing a glance at input operation can be evaded.

While the example embodiments of the present invention have been described above with reference to the drawings, the example embodiments are exemplifications of the present invention, and various configurations other than those described above may be employed.

For example, a plurality of operated apparatuses 10 may include different types of apparatuses. The equipment operation apparatus 100 transmits apparatus identification information to the communication apparatus 200, and the communication apparatus 200 may further include a determination unit (unillustrated) determining the type of an operated apparatus 10 being an operation target, based on the received apparatus identification information. The first transmission unit 208 transmits information for causing the display unit 110 in the equipment operation apparatus 100 to display an operation screen for operating an operated apparatus 10 related to the determined type to the equipment operation apparatus 100 through the first communication unit 202.

The configuration enables operation on a plurality of types of operated apparatuses 10 by one application.

Further, in another example, with regard to operation of a coffee maker at a convenience store, or the like, specification of specifics of a favorite product such as the type of coffee bean, strength, amounts of added sugar and milk (such as increased/decreased/without) may be previously registered for a user-registered user. Specifics of registration may be stored in the storage unit 130 in the mobile terminal 100 of the user U or may be registered in a management server as user registration information.

Further, a timing of acquiring apparatus identification information is when an operated apparatus 10 is operated, according to the aforementioned example embodiment. In another example embodiment, apparatus identification information may be acquired in advance. For example, a QR code including apparatus identification information of an operated apparatus 10 may be provided for various media such as a mail, a flier, a catalog, and a magazine, and the user U may read a QR code of an operated apparatus 10 scheduled to be used in advance by an application. When an operated apparatus 10 is operated, instruction operation of starting use of the operated apparatus 10 by the user U may be accepted on a menu screen of the application, and connection to the controller 20 of the operated apparatus 10 may be started by using apparatus identification information of the operated apparatus 10 acquired in advance.

As an example, a QR code including apparatus identification information related to a building scheduled to be visited may be transmitted to a visitor in advance by mail or the like. The visitor may acquire the apparatus identification information related to the building scheduled to be visited by reading the received QR code by the mobile terminal 100 and for example, may be able to download an operation screen related to the building in advance from a management server. Furthermore, when a floor to be visited is determined, floor number specification information may be further included in the QR code. Use of the floor number specification information eliminates the need for operation of floor number specification by the user U and enables the elevator to be moved to the floor to be visited.

By reading a QR code at an entrance of the building or on the outside operation panel 30 of the elevator at the time of a visit, the mobile terminal 100 can connect to the communication apparatus 200 in the building and operate the elevator. At that time, the display processing unit 104 can cause an operation screen related to the elevator in the building to be displayed by using the operation screen information downloaded in advance.

Further, an expiration date of information recorded in a QR code may be set based on a date and time of visit. When the expiration date has passed, the information recorded in the QR code may be invalidated. The information can be determined by management on the management server side at generation and distribution of the QR code.

While the present invention has been described with reference to the example embodiments and the examples thereof, the present invention is not limited to the aforementioned example embodiments and examples thereof. Various changes and modifications that may be understood by a person skilled in the art may be made to the configurations and details of the present invention without departing from the scope of the present invention.

Note that when information about a user is acquired and used in the present invention, the acquisition and the use are assumed to be performed legally.

The whole or part of the example embodiments disclosed above may also be described as, but not limited to, the following supplementary notes.

1. A program for causing a computer to function as:

a connection unit that acquires apparatus identification information for distinguishing a plurality of apparatuses from each other, and connecting to a communication unit communicable with a control unit of an apparatus indicated by the apparatus identification information;

a display processing unit that, when a connection to the communication unit is established, causes a display unit to display an operation screen for operating the apparatus communicable with the communication unit; and

a transmission unit that transmits an operation instruction input by operating the operation screen to the communication unit and causes the operation instruction to be transferred to the control unit of the apparatus.

2. The program according to 1., wherein

at least one of the apparatuses is an elevator.

3. The program according to 2., further causing the computer to function as

an acquisition unit that acquires the apparatus identification information by reading, by a user, a two-dimensional code provided at an entrance or an elevator hall of a building having the elevator.

4. The program according to 3., wherein

the display processing unit causes the display unit to display at first a destination floor number specification screen for specifying a floor number of a destination of the elevator.

5. The program according to 3., wherein

the display processing unit
causes the display unit to display at first a screen for specifying a moving direction of the elevator after boarding and,
when subsequently acquiring a two-dimensional code in the elevator by the acquisition unit, causes the display unit to display a floor number specification screen for specifying a floor number of a destination of the elevator.
   6. The program according to 3., wherein

the display processing unit causes the display unit to display at first a destination specification screen for specifying a destination of the elevator.

7. The program according to any one of 2. to 6., wherein

floor number information indicating a floor number to which the elevator is movable is associated with the apparatus identification information, and

the display processing unit causes the display unit to display a floor number specification screen for specifying a floor number of a destination of the elevator, based on a floor number indicated by the floor number information associated with the acquired apparatus identification information.

8. The program according to any one of 2. to 7., wherein

the floor number information further includes information about a specific floor requiring input of authentication information in order to be specified as a destination of the elevator,

when the specific floor is specified by a user through the floor number specification screen, the display processing unit further causes the display unit to display an input screen of authentication information, and

the transmission unit transmits the authentication information to the communication unit.

9. The program according to any one of 2. to 8., wherein

the plurality of apparatuses include two or more elevators, and

the two or more elevators are positioned in an identical building.

10. The program according to any one of 2. to 9., wherein

the plurality of apparatuses include two or more elevators, and

the two or more elevators are positioned in buildings different from each other.

11. The program according to any one of 1. to 9., wherein

the computer is a mobile terminal apparatus of a user, and

the transmission unit transmits user identification information allowing determination of a user who uses the mobile terminal apparatus to the communication unit.

12. The program according to any one of 1. to 11., wherein

the plurality of apparatuses include different types of apparatuses,

the program further causes the computer to function as

a determination unit that determines the type of an apparatus being an operation target, based on the apparatus identification information, and

the display processing unit causes the display unit to display an operation screen for operating an apparatus related to the determined type.

13. A communication apparatus including:

a first communication unit that wirelessly communicates with a mobile terminal apparatus including a computer executing the program according to any one of 1. to 12.;

a second communication unit that communicates with control units of a plurality of apparatuses;

a reception unit that, when a connection to the mobile terminal apparatus is established through the first communication unit, receives, from the mobile terminal apparatus, apparatus identification information for distinguishing the plurality of apparatuses from each other;

a first transmission unit that transmits, through the first communication unit, information for causing a display unit in the mobile terminal apparatus to display an operation screen for operating the apparatus, based on the received apparatus identification information; and

a second transmission unit that, when receiving an operation instruction to the apparatus from the mobile terminal apparatus through the first communication unit, transmits the operation instruction to the control unit of the apparatus through the second communication unit.

14. The communication apparatus according to 13., wherein

the second transmission unit transmits, to the control unit of the apparatus, along with the received operation instruction, an instruction not to cause a display unit in the apparatus to display information indicating the operation instruction.

15. The communication apparatus according to 14., wherein

the apparatus is an elevator, and,

when the operation instruction indicates a floor number of a destination of the elevator, the second transmission unit transmits, to the control unit of the elevator, along with information for specifying the floor number of the destination, an instruction not to cause a display unit in the elevator for displaying a floor number of a destination to display the floor number of the destination of the elevator.

16. A communication apparatus control method including, by a communication apparatus including a first communication unit that wirelessly communicates with a mobile terminal apparatus and a second communication unit that communicates with control units of a plurality of apparatuses:

when a connection to the mobile terminal apparatus is established through the first communication unit, receiving, from the mobile terminal apparatus, apparatus identification information for distinguishing the plurality of apparatuses from each other;

transmitting, through the first communication unit, information for causing a display unit in the mobile terminal apparatus to display an operation screen for operating the apparatus, based on the received apparatus identification information; and,

when receiving an operation instruction to the apparatus from the mobile terminal apparatus through the first communication unit, transmitting the operation instruction to the control unit of the apparatus through the second communication unit.

17. The communication apparatus control method according to 16., further including, by the communication apparatus,

transmitting, to the control unit of the apparatus, along with the received operation instruction, an instruction not to cause a display unit in the apparatus to display information indicating the operation instruction.

18. The communication apparatus control method according to 17., wherein

the apparatus is an elevator, and

the communication apparatus control method further includes, by the communication apparatus, when the operation instruction indicates a floor number of a destination of the elevator, transmitting, to the control unit of the elevator, along with information for specifying the floor number of the destination, an instruction not to cause a display unit in the elevator for displaying a floor number of a destination to display the floor number of the destination of the elevator.

19. A program for causing a computer to function as:

a first communication unit that wirelessly communicates with a mobile terminal apparatus;

a second communication unit that communicates with control units of a plurality of apparatuses;

a reception unit that, when a connection to the mobile terminal apparatus is established through the first communication unit, receives, from the mobile terminal apparatus, apparatus identification information for distinguishing the plurality of apparatuses from each other;

a first transmission unit that transmits, through the first communication unit, information for causing a display unit in the mobile terminal apparatus to display an operation screen for operating the apparatus, based on the received apparatus identification information; and

a second transmission unit that, when receiving an operation instruction to the apparatus from the mobile terminal apparatus through the first communication unit, transmits the operation instruction to the control unit of the apparatus through the second communication unit.

20. The program according to 19., wherein

the second transmission unit transmits, to the control unit of the apparatus, along with the received operation instruction, an instruction not to cause a display unit in the apparatus to display information indicating the operation instruction.

21. The program according to 20., wherein

the apparatus is an elevator, and,

when the operation instruction indicates a floor number of a destination of the elevator, the second transmission unit transmits, to the control unit of the elevator, along with information for specifying the floor number of the destination, an instruction not to cause a display unit in the elevator for displaying a floor number of a destination to display the floor number of the destination of the elevator.

22. An information processing system including:

a mobile terminal apparatus operated by a user of an apparatus; and

a communication apparatus communicable with a control unit of the apparatus, wherein

the mobile terminal apparatus includes:
a connection unit that acquires apparatus identification information for distinguishing a plurality of the apparatuses from each other and connects to the communication apparatus communicable with the control unit of an apparatus indicated by the apparatus identification information;
a display processing unit that, when a connection to the communication apparatus is established, causes a display unit to display an operation screen for operating the apparatus communicable with the communication apparatus; and
a transmission unit that transmits an operation instruction input by operating the operation screen to the control unit of the apparatus through the communication apparatus.
   23. The information processing system according to 22., wherein

the communication apparatus includes:
a first communication unit that wirelessly communicates with the mobile terminal apparatus;
a second communication unit that communicates with control units of a plurality of apparatuses;
a reception unit that, when a connection to the mobile terminal apparatus is established through the first communication unit, receives, from the mobile terminal apparatus, apparatus identification information for distinguishing the plurality of apparatuses from each other;
a first transmission unit that transmits, through the first communication unit, information for causing a display unit in the mobile terminal apparatus to display an operation screen for operating the apparatus, based on the received apparatus identification information; and
a second transmission unit that, when receiving an operation instruction to the apparatus from the mobile terminal apparatus through the first communication unit, transmits the operation instruction to the control unit of the apparatus through the second communication unit.
   24. The information processing system according to 22. or 23., wherein

at least one of the apparatuses is an elevator.

25. The information processing system according to 24., wherein

the mobile terminal apparatus further includes an acquisition unit that acquires the apparatus identification information by reading, by a user, a two-dimensional code provided at an entrance or an elevator hall of a building having the elevator.

26. The information processing system according to 25., wherein,

in the mobile terminal apparatus, the display processing unit causes the display unit to display at first a destination specification screen for specifying a destination of the elevator.

27. The information processing system according to any one of 24. to 26., wherein

floor number information indicating a floor number to which the elevator is movable is associated with the apparatus identification information, and,

in the mobile terminal apparatus, the display processing unit causes the display unit to display a floor number specification screen for specifying a floor number of a destination of the elevator, based on a floor number indicated by the floor number information associated with the acquired apparatus identification information.

28. The information processing system according to 27., wherein

the floor number information further includes information about a specific floor requiring input of authentication information in order to be specified as a destination of the elevator, and,

in the mobile terminal apparatus,
when the specific floor is specified by a user through the floor number specification screen, the display processing unit further causes the display unit to display an input screen of authentication information, and
the transmission unit transmits the authentication information to the communication apparatus.
   29. The information processing system according to any one of 24. to 28., wherein,

in the mobile terminal apparatus, the transmission unit transmits user identification information allowing determination of a user who uses the mobile terminal apparatus to the communication apparatus.

30. The information processing system according to any one of 24. to 29., wherein

a plurality of the apparatuses include different types of apparatuses,

the mobile terminal apparatus further includes a determination unit that determines the type of an apparatus being an operation target, based on the apparatus identification information, and,

in the mobile terminal apparatus, the display processing unit causes the display unit to display an operation screen for operating an apparatus related to the determined type.

31. An information processing system including:

a mobile terminal apparatus operated by a user of an apparatus; and

a communication apparatus communicable with a control unit of the apparatus, wherein

the mobile terminal apparatus includes:
a connection unit that connects to the communication apparatus;
a display processing unit that, when a connection to the communication apparatus is established, causes a display unit to display an operation screen for operating the apparatus communicable with the communication apparatus; and
a transmission unit that transmits an operation instruction input by operating the operation screen to the control unit of the apparatus through the communication apparatus, and

the communication apparatus includes:
a first communication unit that wirelessly communicates with the mobile terminal apparatus;
a second communication unit that communicates with the control unit of a plurality of the apparatuses;
a reception unit that, when a connection to the mobile terminal apparatus is established through the first communication unit, receives, from the mobile terminal apparatus, apparatus identification information for distinguishing the plurality of apparatuses from each other;
a first transmission unit that transmits, through a first communication unit, information for causing a display unit in the mobile terminal apparatus to display the operation screen for operating the apparatus, based on the received apparatus identification information; and
a second transmission unit that, when receiving an operation instruction to the apparatus from the mobile terminal apparatus through the first communication unit, transmitting, to the control unit of the apparatus through the second communication unit, along with the operation instruction, an instruction not to cause a display unit in the apparatus to display information indicating the operation instruction.
   32. The information processing system according to 31., wherein

at least one of the apparatuses is an elevator.

33. The information processing system according to 32., wherein

the mobile terminal apparatus further includes an acquisition unit that acquires the apparatus identification information by reading, by a user, a two-dimensional code provided at an entrance or an elevator hall of a building having the elevator.

34. The information processing system according to 33., wherein,

in the mobile terminal apparatus, the display processing unit causes the display unit to display at first a destination specification screen for specifying a destination of the elevator.

35. The information processing system according to any one of 32. to 34., wherein

floor number information indicating a floor number to which the elevator is movable is associated with the apparatus identification information, and,

in the mobile terminal apparatus, the display processing unit causes the display unit to display a floor number specification screen for specifying a floor number of a destination of the elevator, based on a floor number indicated by the floor number information associated with the acquired apparatus identification information.

36. The information processing system according to 35., wherein

the floor number information further includes information about a specific floor requiring input of authentication information in order to be specified as a destination of the elevator, and,

in the mobile terminal apparatus,
when the specific floor is specified by a user through the floor number specification screen, the display processing unit further causes the display unit to display an input screen of authentication information, and
the transmission unit transmits the authentication information to the communication apparatus.
   37. The information processing system according to any one of 31. to 36., wherein,

in the mobile terminal apparatus, the transmission unit transmits user identification information allowing determination of a user who uses the mobile terminal apparatus to the communication apparatus.

38. The information processing system according to any one of 31. to 37., wherein

the plurality of apparatuses include different types of apparatuses,

the mobile terminal apparatus further includes a determination unit that determines the type of an apparatus being an operation target, based on the apparatus identification information, and,

in the mobile terminal apparatus, the display processing unit causes the display unit to display an operation screen for operating an apparatus related to the determined type.

39. The information processing system according to any one of 31. to 38., wherein

the second transmission unit in the communication apparatus transmits, to the control unit of the apparatus, along with the received operation instruction, an instruction not to cause a display unit in the apparatus to display information indicating the operation instruction.

40. The information processing system according to 39., wherein

the apparatus is an elevator, and,

when the operation instruction indicates a floor number of a destination of the elevator, the second transmission unit in the communication apparatus transmits, to the control unit of the elevator, along with information for specifying the floor number of the destination, an instruction not to cause a display unit in the elevator for displaying a floor number of a destination to display the floor number of the destination of the elevator.

This application claims priority based on Japanese Patent Application No. 2020-107864 filed on Jun. 23, 2020, the disclosure of which is hereby incorporated by reference thereto in its entirety.

### REFERENCE SIGNS LIST

1 Information processing system
10 Operated apparatus (elevator)

### 20 Controller

30 Outside operation panel
34 QR code
50 Inside operation panel
54 QR code
100 Equipment operation apparatus (mobile terminal)
102 Connection unit
104 Display processing unit
106 Transmission unit
110 Display unit
112 Apparatus identification number acquisition unit
130 Storage unit
200 Communication apparatus
202 First communication unit
204 Second communication unit
206 Reception unit
208 First transmission unit
210 Second transmission unit
230 Storage unit
300 Code readout screen
320 Up-down specification screen
340 Apparatus arrival standby screen
350 Destination floor specification screen
360 Destination arrival standby screen

### 1000 Computer

### 1010 Bus

### 1020 Processor

### 1030 Memory

1040 Storage device
1050 Input-output interface
1060 Network interface

What is claimed is:

1. A non-transitory computer-readable storage medium storing a program for causing a computer to execute the instructions to:
acquire apparatus identification information for distinguishing a plurality of apparatuses from each other, and connect to a communication unit communicable with a control unit of an apparatus indicated by the apparatus identification information;
when a connection to the communication unit is established, cause a display unit to display an operation screen for operating the apparatus communicable with the communication unit; and
transmit an operation instruction input by operating the operation screen to the communication unit and causes the operation instruction to be transferred to the control unit of the apparatus.

2. The non-transitory computer-readable storage medium according to claim 1, wherein
at least one of the apparatuses is an elevator.

3. The non-transitory computer-readable storage medium according to claim 2, wherein the program further causes the computer to execute the instructions to
acquire the apparatus identification information by reading, by a user, a two-dimensional code provided at an entrance or an elevator hall of a building having the elevator.

4. The non-transitory computer-readable storage medium according to claim 3, wherein the program further causes the computer to execute the instructions to
cause the display unit to display at first a destination floor number specification screen for specifying a floor number of a destination of the elevator.

5. The non-transitory computer-readable storage medium according to claim 3, wherein the program further causes the computer to execute the instructions to
cause the display unit to display at first a screen for specifying a moving direction of the elevator after boarding and,
when subsequently acquiring the two-dimensional code in the elevator by the acquisition unit, cause the display unit to display a floor number specification screen for specifying a floor number of a destination of the elevator.

6. The non-transitory computer-readable storage medium according to claim 3, wherein the program further causes the computer to execute the instructions to
cause the display unit to display at first a destination specification screen for specifying a destination of the elevator.

7. The non-transitory computer-readable storage medium according to claim 2, wherein
floor number information indicating a floor number to which the elevator is movable is associated with the apparatus identification information, and
the program further causes the computer to execute the instructions to
cause the display unit to display a floor number specification screen for specifying a floor number of a destination of the elevator, based on a floor number indicated by the floor number information associated with the acquired apparatus identification information.

8. The non-transitory computer-readable storage medium according to claim 7, wherein
the floor number information further includes information about a specific floor requiring input of authentication information in order to be specified as a destination of the elevator,
the program further causes the computer to execute the instructions to
when the specific floor is specified by a user through the floor number specification screen, further cause the display unit to display an input screen of authentication information, and
transmit the authentication information to the communication unit.

9. The non-transitory computer-readable storage medium according to claim 2, wherein
the plurality of apparatuses include two or more elevators, and
the two or more elevators are positioned in an identical building.

10. The non-transitory computer-readable storage medium according to claim 2, wherein
the plurality of apparatuses include two or more elevators, and
the two or more elevators are positioned in buildings different from each other.

11. The non-transitory computer-readable storage medium according to claim 1, wherein
the computer is a mobile terminal apparatus of a user, and
the program further causes the computer to execute the instructions to
transmit user identification information allowing determination of a user who uses the mobile terminal apparatus to the communication unit.

12. The non-transitory computer-readable storage medium according to claim 1, wherein
the plurality of apparatuses include different types of apparatuses,
the program further causes the computer to execute the instructions to
determine the type of an apparatus being an operation target, based on the apparatus identification information, and
cause the display unit to display an operation screen for operating an apparatus related to the determined type.

13. A communication apparatus comprising:
at least one memory configured to store instructions; and
at least one processor configured to execute the instructions to:
wirelessly communicate with a mobile terminal apparatus including a computer executing the program stored in a non-transitory computer-readable storage medium according to claim 1;
communicate with control units of a plurality of apparatuses;
when a connection to the mobile terminal apparatus is established through the first communication unit, receive, from the mobile terminal apparatus, apparatus identification information for distinguishing the plurality of apparatuses from each other;
transmit, through the first communication unit, information for causing a display unit in the mobile terminal apparatus to display an operation screen for operating the apparatus, based on the received apparatus identification information; and
when receiving an operation instruction to the apparatus from the mobile terminal apparatus through the first communication unit, transmit the operation instruction to the control unit of the apparatus through the second communication unit.

14. The communication apparatus according to claim 13, wherein
the at least one processor is further configured to execute the instructions to
transmit, to the control unit of the apparatus, along with the received operation instruction, an instruction not to cause a display unit in the apparatus to display information indicating the operation instruction.

15. The communication apparatus according to claim 14, wherein
the apparatus is an elevator, and,
the at least one processor is further configured to execute the instructions to
when the operation instruction indicates a floor number of a destination of the elevator, transmit, to the control unit of the elevator, along with information for specifying the floor number of the destination, an instruction not to cause a display unit in the elevator for displaying a floor number of a destination to display the floor number of the destination of the elevator.

16-30. (canceled)

31. An information processing system comprising:
a mobile terminal apparatus operated by a user of an apparatus; and
a communication apparatus communicable with a control unit of the apparatus, wherein
the mobile terminal apparatus includes:
at least one memory configured to store instructions; and
at least one processor configured to execute the instructions to:
connect to the communication apparatus;
when a connection to the communication apparatus is established, cause a display unit to display an operation screen for operating the apparatus communicable with the communication apparatus; and
transmit an operation instruction input by operating the operation screen to the control unit of the apparatus through the communication apparatus, and
the communication apparatus includes:
at least one memory configured to store instructions; and
at least one processor configured to execute the instructions to:
wirelessly communicate with the mobile terminal apparatus;
communicate with the control unit of a plurality of the apparatuses;
when a connection to the mobile terminal apparatus is established through the first communication unit, receive, from the mobile terminal apparatus, apparatus identification information for distinguishing the plurality of apparatuses from each other;
transmit, through the first communication unit, information for causing display unit in the mobile terminal apparatus to display the operation screen for operating the apparatus, based on the received apparatus identification information; and
when receiving an operation instruction to the apparatus from the mobile terminal apparatus through the first communication unit, transmit, to the control unit of the apparatus through the second communication unit, the received operation instruction.

32. The information processing system according to claim 31, wherein
at least one of the apparatuses is an elevator.

33. The information processing system according to claim 32, wherein
in the mobile terminal apparatus, the at least one processor is further configured to execute the instructions to acquire the apparatus identification information by reading, by a user, a two-dimensional code provided at an entrance or an elevator hall of a building having the elevator.

34. The information processing system according to claim 33, wherein,
in the mobile terminal apparatus, the at least one processor is further configured to execute the instructions to cause the display unit to display at first a destination specification screen for specifying a destination of the elevator.

35. The information processing system according to claim 32, wherein
floor number information indicating a floor number to which the elevator is movable is associated with the apparatus identification information, and,
in the mobile terminal apparatus, the at least one processor is further configured to execute the instructions to cause the display unit to display a floor number specification screen for specifying a floor number of a destination of the elevator, based on a floor number indicated by the floor number information associated with the acquired apparatus identification information.

36-40. (canceled)
